(19) United States
(12) Patent Application Publication
(10) Pub. No.: US 2004/0244891 A1
(43) Pub. Date: Dec. 9, 2004

(54) Internal buttress for tire bead retention

(76) Inventors: Kenneth Dewing, Porterville, CA (US); Russell Sarno, Valencia, CA (US)

Correspondence Address: DONALD D. MON, ATTORNEY AT LAW, 750 EAST GREEN STREET, SUITE 303, PASADENA, CA, 91101, US

(21) Appl. No.: 10/455,236

(22) Filed: Jun. 5, 2003

(51) Int. Cl. B60C 1/00

(52) U.S. Cl. 152/151

(57) ABSTRACT

A buttress to fit inside a tire between its beads, said beads being abutted by respective wheel rims. The buttress is formed by joining a plurality of arcuate segments. Each segment has an arcuate central and two edge walls. Each one of a plurality of blades is integral with all of the walls. The blades are parallel so the entire segment can be made by an injection molding process.

### FIELD OF THE INVENTION

Retention to a wheel for tubeless tires that are prone to loss of inflating air pressure, or which are intended to run with very low or even no pressure.

### BACKGROUND OF THE INVENTION

Vehicular tires are regularly held to their wheel by the reaction between internal pneumatic pressure, the strength of the bead of the tire, and the surrounding wheel and rim construction. The situation is simple and well known for automotive tires which bear light loads and whose failure modes generally involve a gradual loss of pressure and an acceptable mode of release of the tire from the wheel. Examples are tire valve failures, valve stem leakage, minor punctures, and low speed blowouts.

For more stringent applications, self-sealing systems have been proposed. With these systems, sealants inside the tire are relied on to plug leaks when they occur. These are principally intended to extend the time of failure of inflation and to give the operator more time to control his vehicle.

There is a class of vehicle, generally thought of as military or paramilitary in nature, where loss of inflation is not the primary risk. Instead the major risk is loss of the tire itself. It is very desirable and often critical for the vehicle to be able to proceed after an unfortunate event, or to proceed routinely with a tire having very low (or no) pneumatic pressure, a situation which often would be called a flat tire.

An example of an unintended run on a flat tire is where the vehicle is armored, or is a personnel carrier, or any one of many types of vehicles which operate in unfriendly circumstances, and gunfire or spike strips are used against them. Then to be stopped by a flat or lost tire is an intolerable risk to life itself. Another example is when, due to local conditions, it is intentionally run on tires with very low pressure, perhaps only 8 psi. Again successful operation depends on retention of the tire for completion of the task.

It is an object of this invention to provide a buttress to hold the beads of a tire to wheels and rims in such a way that the beads are mechanically gripped and the tire is held to the wheel at the bead whether the tire is inflated or not. The buttress itself is sufficient to hold the beads to the wheel of course, any inflation pressure assists in retention.

It is another object of this invention to provide a buttress with the necessary columnar strength to do its mechanical job, but with minimal weight. This weight is “unsprung”, and in that sense should be minimized. Accordingly, this invention contemplates a buttress structure with substantial voids and least weight. Steel buttresses for the intended purpose can weigh as much as 34 pounds. A buttress according to this invention can weigh as little as 4½ pounds for the same wheel and tire because it can be made of a minimum amount of light weight plastic material.

Affordability is another issue. Tires of the type which employ this invention are made and used in the hundreds of thousands, and so are their wheels. Metal structures, and plastic structures which are made with machinery that requires substantial process time are inherently expensive. It is an object of this invention to provide a buttress having adequate strength, light weight, and which can be manufactured economically with injection molding processes. These processes are quite rapid, so that the cost of product is greatly reduced. This product thereby becomes more affordable.

### BRIEF DESCRIPTIONS OF THE INVENTION

A buttress according to this invention comprises a rigid body formed in arcuate segments joined to make a circular body with exterior shapes so proportioned and arranged as to fit adjacent to a central surface of a wheel and between beads of a tire.

The buttress includes a plurality of blades that extend parallel to each other, and also to the axis of the wheel when installed, and which are bounded on three sides by walls integral with them.

The wheel itself includes an integral rim contiguous to its central surface. Wheel bolts and nuts draw a separate rim toward the wheel.

The tire, with the buttress between its beads, is placed between the two rims. The separate rim is then drawn against the tire, which compresses the beads and the buttress into a lateral stack which compressively holds the tire to the rims by the beads, making an air tight seal while doing so. The buttress is made by injection molding.

The term “bead” as used herein is intended to mean not only the conventional metallic hoop-like internal reinforcement of a tire, but also the flexible tire material that surrounds and embeds it.

The above and other features of this invention will be fully understood from the following detailed description and the accompanying drawings, in which:

### BRIEF DESCRIPTION OF THE DRAWINGS

FIG. 1 is an oblique view of an assembled buttress;

FIG. 2 is a plan view of the buttress of FIG. 1;

FIG. 3 is a side view of a typical joinder for adjacent segments;

FIG. 4 is a lateral cross-section view of a segment; and

FIG. 5 is an axial cross-section of a mounted assembly.

### DETAILED DESCRIPTION OF THE INVENTION

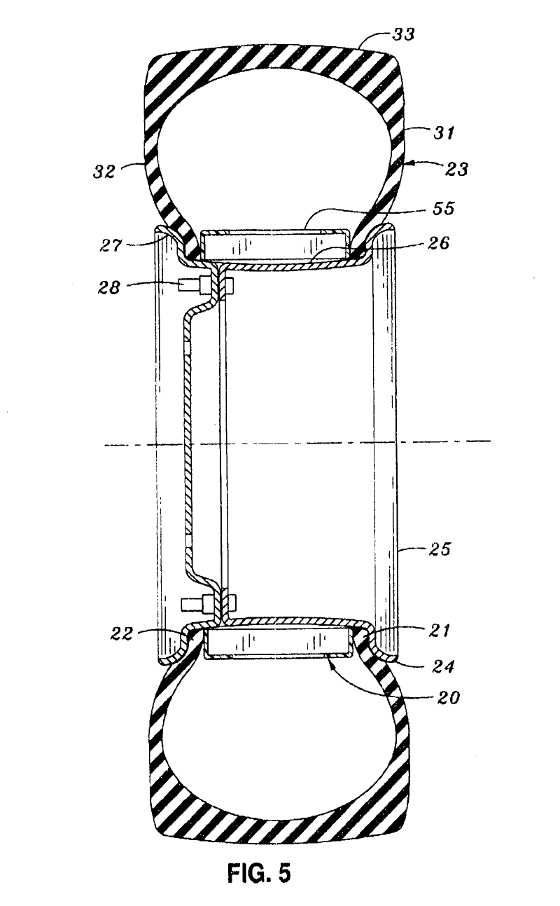

As best shown in FIG. 5, the function of buttress 20 is to provide lateral compressive support against beads 21, 22 of a tire 23. Bead 21 bears against an internal rim 24 of a wheel 25. Rim 24 is integral with the wheel. The wheel has a continuous central surface 26 extending completely around the inside of the wheel. Rim 24 is continuous with, and contiguous to, central surface 26.

A separate rim 27 is held to the wheel by wheel bolts 28 and bears against bead 22 from the outside. Thus tightening the bolts presses the separate rim against bead 22, which in turn presses against the buttress. In turn the buttress presses against bead 21, which then bears strongly against rim 24. There results a solid stack holding the beads to the wheel, which forms a fluid-tight seal on both of the beads that closes the inflation region 30 inside the tire. The sidewalls 31, 32 and tread 33 are shown in the drawing and complete the enclosure.

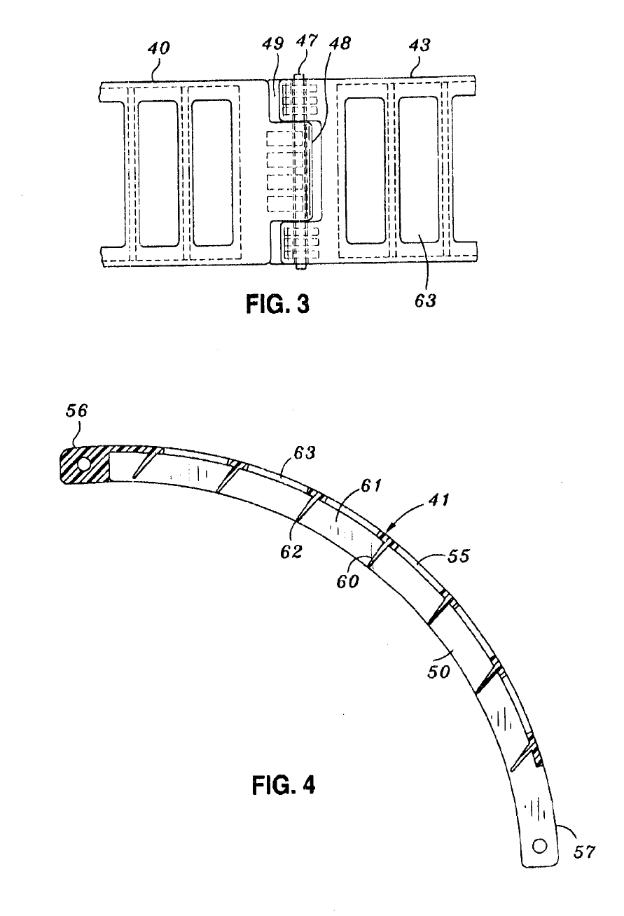

The buttress will be formed from a plurality (preferably four) of arcuate segments 40, 41, 42, 43 (FIG. 2) joined at their end intersections by pins 44, 45, 46, 47 respectively. These pins pass through aligned holes in tongues 48 on one segment and 49 on its neighboring segment (FIG. 3). These pins can be pressed in when the segments are assembled to form a ring which is inserted into the tire before it is mounted to the wheel.

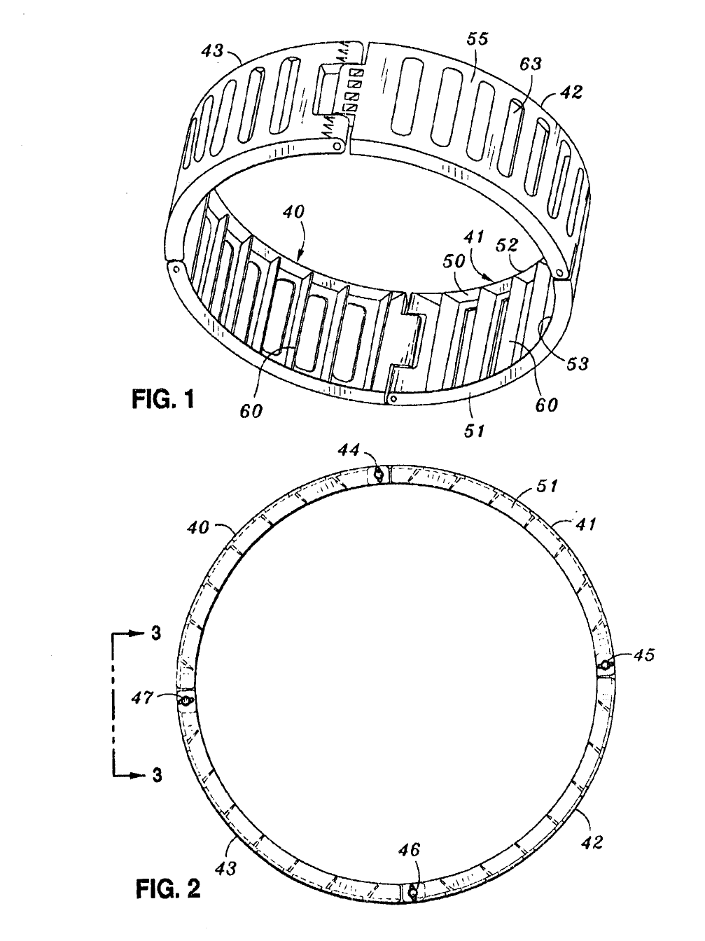

The segments are identical, so only segment 41 will be described in detail in FIGS. 1, 2 and 4. It includes edge walls 50, 51 which are parallel to each other and are spaced apart from one another. They terminate in free arcuate edges 52, 53, respectively, which will face the inside of the wheel.

A central wall 55 (when the segment is installed) will face into the inside of the tire. It extends from edge wall to edge wall, and from tongues 56, 57 at each of the ends of the segment.

Blades 60 extend between the edge walls and inner wall. Importantly to this invention, they are parallel to one another and are formed integrally with the walls. This construction forms a box-like open region 61 between each pair of blades, open at edges 62.

Inner wall 55 may have lightening apertures 63 in areas between the blades of each pair. These are optional, but do result in reduction of unsprung weight.

The dimensions and materials are selected for the size of the installation and the anticipated conditions of usage. There are heat and pressure to be considered. Generally a moldable thermoplastic material is suitable, provided that it can be injection molded. Polyethylene, polypropylene and various engineered resins with appropriate physical properties are possible material options.

Buttresses have elsewhere been suggested that are made by rotational molding, and they function well. However, their production rate tends toward one hour per buttress per mold cavity. This is costly for machine and operator time. In contrast, an injection molded part according to this invention can be made in about one tenth of the time, and produces a functionally equal product.

Lateral compression of the buttress between the edge faces is the primary structural requirement. This is resisted principally by the blades, which must be reasonably stiff, and which are also supported by the edge faces and inner face with which they are integral. These together form open ended boxes formed by blades and faces, all of which tend to resist wrinkling and other deformation.

Because the blades are parallel conventional injection molds can be used because the tooling plug can be pulled directly out after the part is formed. These blades are not radially oriented, because it is not their function directly to resist radial forces, and if they were, the part could not be made by an injection process. Theirs is a columnar support between the two edge faces.

Suitable dimensions for a 90 degrees segment for use on a 20 inch wheel are approximately as follows. Dimensions are in inches. For wheels of different sizes, the dimensions will be suitably selected.

Radius of inner edges: 52,53 about 10 inches

Radius of inner wall 55: about 11 inches

Separation of the edge faces: dependent on the tire and its dimensions, and on the rims and their dimensions

Wall thickness of the vanes and walls: between about 0.150 and about 0.200 inches

Number of vanes: varies, usually seven

The rigid, readily formed and relatively light weight buttress provides mechanical support to the beads of the tire in addition to pneumatic forces which will retain the tire to the wheel even when there is little or no pressure left in the tire.

This invention is not to be limited by the embodiment shown in the drawings and described in the description, which is given by way of example and not of limitation, but only in accordance with the scope of the appended claims.

We claim:

1. In combination:
a pneumatic vehicular tire having a tread, two beads, and two sidewalls extending between the tread and the beads to form an inflation region;
a wheel to which said tire is mounted, said wheel comprising structure forming an internal peripheral central surface, an integral rim adjacent to said central surface at one edge thereof, a separate rim adapted to be held to said structure adjacent to said central surface, and rim retainers holding said separate rim to said structure whereby said tire can surround said central surface with its beads adjacent to respective said rims;
a buttress comprising a plurality of arcuate segments joined to one another so as to create a ring extending around said central surface, each said segment comprising a unitary structure, said structure comprising:
a pair of spaced-apart edge walls, an inner wall, and a plurality of blades, said walls and blades being continuous and integral with one another, said blades being flat and parallel to one another, whereby to form, along with said faces and adjacent blades, box-like structures with an open end facing away from said inner wall, said inner wall, and the boundaries of the edge faces being arcuate and coaxial; and
engagement means at opposite ends of said segments adapted to be joined to form a complete ring;
said buttress being sandwiched between said beads, whereby said rims when said rim retainers are tightened compress the beads and buttress between them to hold the beads to the wheel.

2. A combination according to claim 1 in which said segments are formed by an injection molding process.

3. A combination according to claim 2 in which said segments are formed of a plastic material.

4. A buttress for placement between two beads of a vehicular tire surrounding a wheel, said buttress comprising a plurality of arcuate segments joined to one another so as to create a ring extending around a central surface of said wheel, each said segment comprising a unitary structure, said structure comprising:
a pair of spaced-apart edge walls, an inner wall, and a plurality of blades, said walls and blades being continuous and integral with one another, said blades being flat and parallel to one another, whereby to form, along with said walls and adjacent blades, box-like structures with an open end facing away from said inner wall, said inner wall, and the boundaries of the edge walls being arcuate and coaxial; and
engagement means at opposite ends of said segments adapted to be joined to form a complete circular structure.

5. A buttress according to claim 4 in which said segments are formed by an injection molding process.

6. A buttress according to claim 5 in which said segments are formed of a plastic material.
